(19) United States
(12) Patent Application Publication
(10) Pub. No.: US 2007/0157674 A1
(43) Pub. Date: Jul. 12, 2007

(54) Apparatus for fabricating optical fiber preform and method for fabricating low water peak fiber using the same

(75) Inventors: Young-Sik Yoon, Chilgok-gun (KR); Mun-Hyun Do, Chilgok-gun (KR); Jin-Haing Kim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/545,847

(22) Filed: Oct. 11, 2006

(30) Foreign Application Priority Data
Jan. 11, 2006 (KR) 2006-3295

(51) Int. Cl. C03B 37/018; C03B 37/01; C03B 37/10

(52) U.S. Cl. 65/414; 65/426; 65/427

(57) ABSTRACT

Disclosed is a method for fabricating an optical fiber preform. The method includes: (a) growing a first soot preform on a starting member along a lengthwise direction of the starting member by a soot deposition; (b) dehydrating the first soot preform; (c) sintering the dehydrated first soot preform, to obtain a first glassed optical preform; and (d) elongating the first optical fiber preform by heating the first optical fiber with a heat source that excludes hydrogen, wherein the first glassed optical fiber is elongated by means of only a heat source that excludes the use of hydrogen.

### CLAIM OF PRIORITY

This application claims priority to application entitled “Apparatus For Fabricating Optical Fiber Preform And Method For Fabricating Low Water Peak Fiber Using the Same” filed with the Korean Intellectual Property Office on Jan. 11, 2006 and assigned Serial No. 2006-3295, the contents of which are incorporated herein by reference.

### BACKGROUND OF THE INVENTION

1. Field of the Invention

The present invention relates to an optical fiber preform, more particularly to a method for fabricating an optical fiber preform using soot deposition and a method for fabricating a low water peak optical fiber.

2. Description of the Related Art

Known methods for fabricating an optical fiber preform include a modified chemical vapor deposition (MCVD), a vapor axial deposition (VAD), an outside vapor deposition (OVD), a plasma chemical vapor deposition (PCVD), etc.

In the vapor axial deposition method, a source material and fuel gas, etc. are supplied to a burner, so that soot is generated by flame hydrolysis. Then, the generated soot is deposited on a starting member. Further, a soot preform is grown from an end portion of the starting member along a lengthwise direction of the starting member.

FIG. 1 is a flowchart illustrating a conventional method for fabricating an optical fiber preform. The method includes steps (a) to (f) S11, S12, S13, S14, S15, and S16.

The step (a) S11 is a process for growing a first soot preform on a starting member by soot deposition. The starting member is rotated and moved upward, while the first soot preform is grown on an end portion of the starting member by using the first and second fixed burners for spraying soot. The first soot preform includes a core having a high refractive index, and an inner clad having a low refraction index and surrounding the core. The first burner sprays the soot toward the end portion of the first soot preform so as to grow the core, while the second burner sprays the soot toward a peripheral surface of the core so as to grow the inner clad.

The step (b) S12 is a process for dehydrating the first soot preform. Specifically, the first soot preform is heated in an atmosphere of chlorine gas, and thereby an OH radical and impurities existing in the first soot preform are removed.

The step (c) S13 is a process for sintering the first soot preform which is dehydrated, so as to obtain the first optical fiber preform which is glassed. Specifically, the first dehydrated soot preform is heated in an atmosphere of helium gas, thereby making it possible to sinter the first opaque soot preform so as to obtain the first transparent optical fiber preform.

The step (d) S14 is a process for heating and elongating the first optical fiber preform by using an oxyhydrogen flame (H₂/O₂ flame). Specifically, the diameter of the first optical fiber preform is reduced while a length of the first optical fiber preform is extended. The first optical fiber preform is heated and softened by the flame of the burner and then the end portion of the first optical fiber preform is drawn so as to elongate the first optical fiber preform. Next, the elongated first optical fiber preform is cut and divided into two parts.

The step (e) S15 is a process for growing an outer clad on the first cut optical fiber preform in a radial direction of the first optical fiber preform by the soot deposition, so as to obtain the second soot preform.

The step (f) S16 is a process for sintering the second soot preform so as to obtain a second optical preform which is glassed.

Then, the end portion of the second optical fiber preform is melted, and thereby the optical fiber having a small diameter can be drawn therefrom.

In the method for fabricating the optical fiber preform as described above, however, since the first optical fiber preform is elongated by the oxyhydrogen flame heating, the hydrogen is easily permeated into the core of the first elongated optical fiber preform. Thus, it is difficult to fabricate a low water peak optical fiber. The low water peak optical fiber refers to an optical fiber adapted to the standard of ITU-T G652C or G652D. Specifically, the low water peak optical fiber has the peak value of 0.4 dB/km in a wavelength of 1310˜1625 nm. After being subjected to hydrogen aging, the low water peak optical fiber has the characteristic in that the loss value at a wavelength of 1383 nm is smaller than that at a wavelength of 1310 nm.

On the other hand, in order to minimize the permeation of hydrogen, it is possible to allow the ratio D/d of the diameter D of the inner clad to the diameter d of the core in the first elongated optical fiber preform to exceed 5.0. However, in this case, there is a problem in that the manufacturing cost and time of the first elongated optical fiber preform increases.

### SUMMARY OF THE INVENTION

Accordingly, the present invention provides a method for fabricating an optical fiber preform and a method for fabricating a low water peak optical fiber using the same, which can minimize a permeation of hydrogen into a core so as to reduce a manufacturing cost and time of the optical fiber preform, thereby facilitating the fabrication of the low water peak optical fiber.

According to an aspect of the present invention, there is provided a method for fabricating an optical fiber preform, comprising the steps of: (a) growing by a soot deposition a first soot preform on a starting member along a lengthwise direction of the starting member; (b) dehydrating the first soot preform; (c) sintering the first soot dehydrated preform, to obtain a first glassed optical preform; and (d) elongating the first glassed optical fiber preform by heating the first glassed optical fiber with a heat source that excludes the use of hydrogen.

According to another aspect of the present invention, there is provided a method for fabricating a low water peak optical fiber, comprising the steps of: (a) growing by a soot deposition a first soot preform on a starting member along a lengthwise direction of the starting member; (b) dehydrating the first soot preform; (c) sintering the first dehydrated soot preform to obtain a first glassed optical preform; (d) elongating the first glassed optical fiber preform by heating the first glassed optical fiber preform with a heat source that excludes the use of hydrogen; (e) growing an outer clad on the first elongated glassed optical fiber preform by a soot deposition, to obtain a second soot preform; (f) dehydrating and sintering the second soot preform to obtain a second glassed optical fiber preform; and (g) drawing a low water peak optical fiber by heating and melting an end portion of the second glassed optical fiber preform.

### BRIEF DESCRIPTION OF THE DRAWINGS

The above and other features and advantages of the present invention will be more apparent from the following detailed description taken in conjunction with the accompanying drawings, in which:

FIG. 1 is a flowchart illustrating a conventional method for fabricating an optical fiber preform;

FIG. 2 is a flowchart illustrating a method for fabricating an optical fiber preform according to a preferred embodiment of the present invention;

FIG. 3 is a view illustrating a step for growing a first soot preform;

FIG. 4 is a view illustrating a step for dehydrating the first soot preform;

FIG. 5 is a view illustrating a step for sintering the first dehydrated soot preform;

FIGS. 6 to 8 are views illustrating steps for heating and elongating the first optical fiber preform;

FIG. 9 is a cross-sectional view showing the first elongated optical fiber;

FIG. 10 is a view illustrating a step for growing an outer clad;

FIG. 11 is a view illustrating steps for dehydrating and sintering a second soot preform;

FIG. 12 is a view showing the second optical fiber preform;

FIG. 13 is a view illustrating a step for drawing a low water peak optical fiber; and

FIG. 14 is a graph showing characteristics of the low water peak optical fiber.

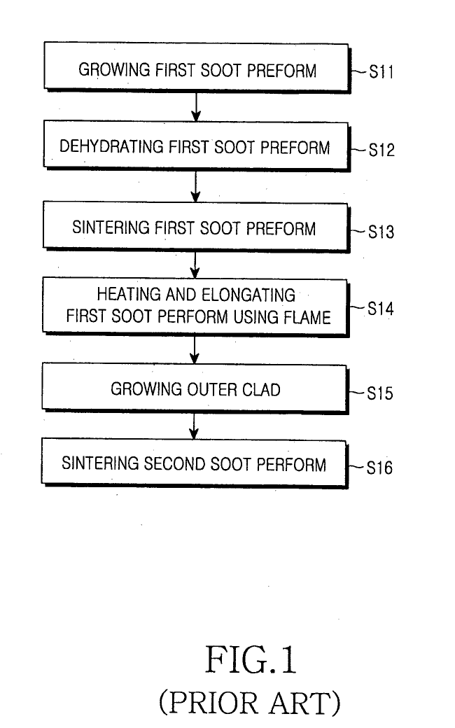

### DETAILED DESCRIPTION OF THE INVENTION

Hereinafter, an embodiment of the present invention is described with reference to the accompanying drawings. For the purposes of clarity and simplicity, a detailed description of known functions and configurations incorporated herein is omitted to avoid making the subject matter of the present invention unclear.

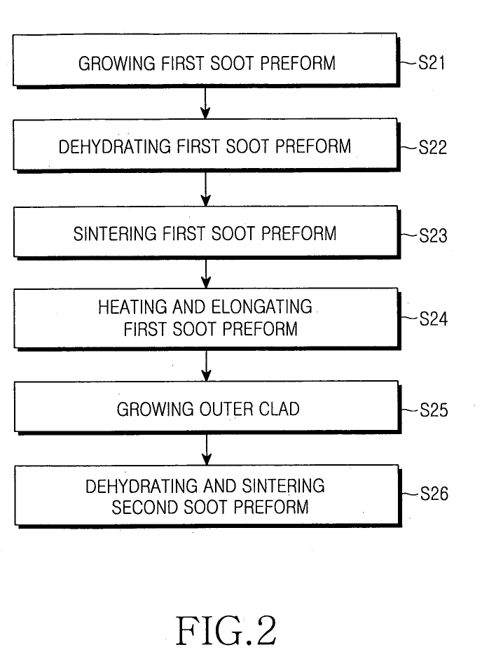

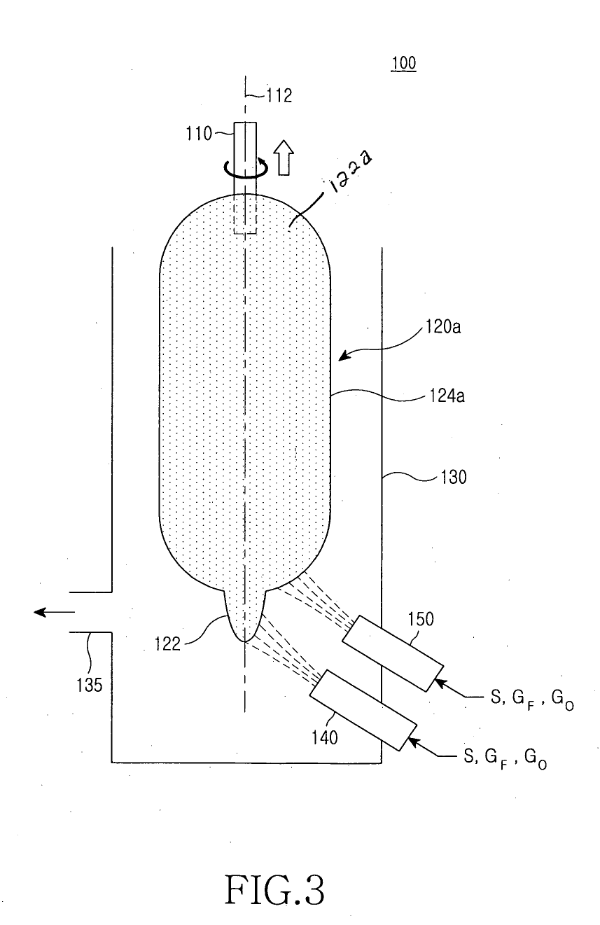

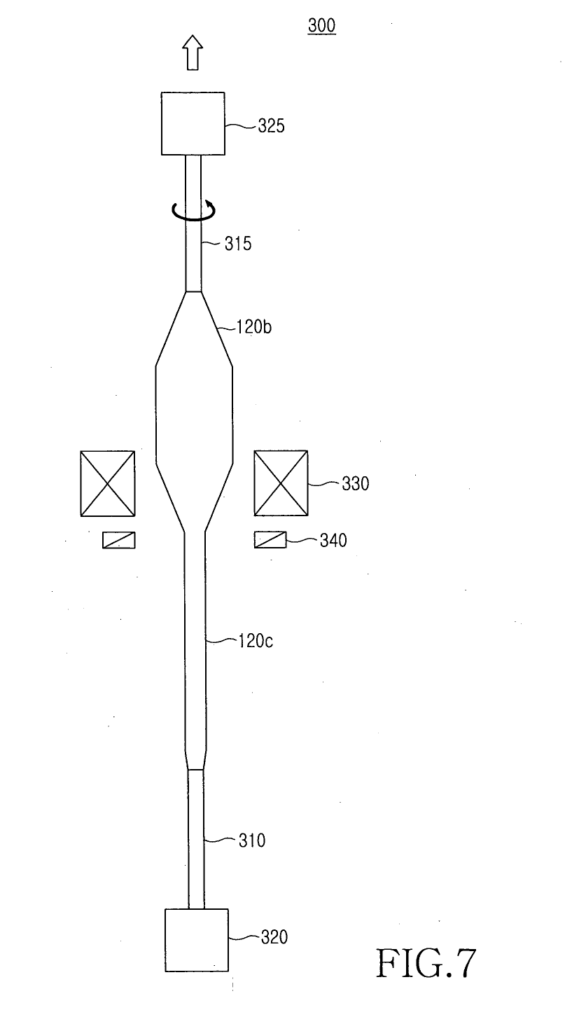

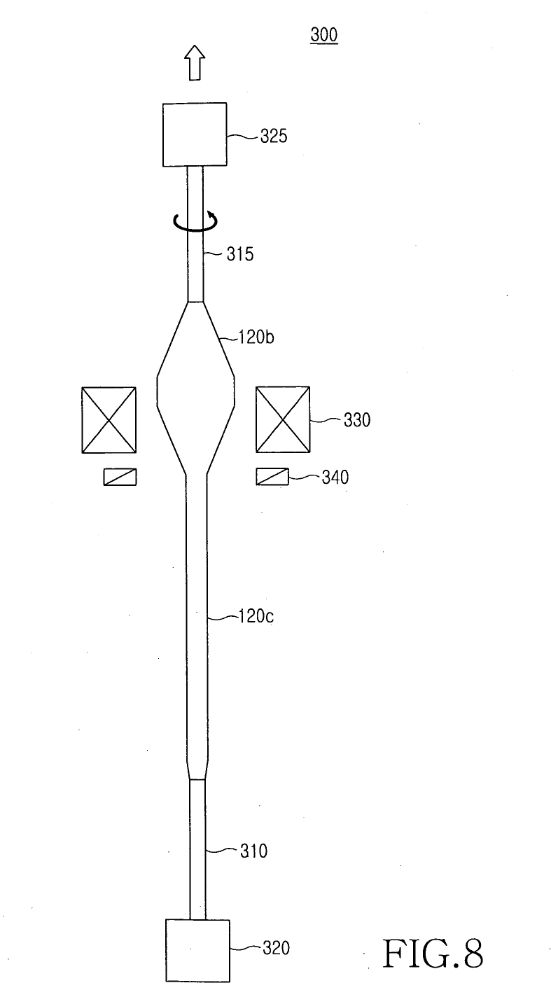

FIG. 2 is a flowchart illustrating a method for fabricating an optical fiber preform according to a preferred embodiment of the present invention, and FIGS. 3 to 12 are views illustrating steps thereof for fabricating the optical fiber preform. The method for fabricating the optical fiber preform includes steps (a), (b), (c), (d), (e), and (f) S21, S22, S23, S24, S25, and S26 of FIG. 2.

The step (a) S21 is a process for growing a first soot preform on a starting member in a lengthwise direction of the starting member by a soot deposition.

FIG. 3 is a view illustrating the step (a) S21 for growing the first soot preform. An apparatus 100 for fabricating the optical fiber preform, illustrated in FIG. 3, includes a deposition chamber 130 and first and second burners 140 and 150.

The deposition chamber 130 comprises a cylinder shape having an inner space, and includes an exhaust port 135 at one side thereof, and the first and second burners 140 and 150 installed at another side thereof.

In a step of preparing a starting member before the step (a) S21, a starting member 110 having an end portion is installed in the deposition chamber 130. The first soot preform 120a is grown from the end portion of the starting member 110 in a lengthwise direction of the starting member 110 by a soot deposition. The first soot perform 120a includes a core 122a located at a center thereof, and an inner clad 124a directly formed on a periphery of the core 122a. The core 122a has a relatively high refractive index, while the inner clad 124a surrounding the core 122a has a relatively low refractive index. In an early stage of the soot deposition, the soot is deposited on the end portion of the starting member 110 by using the second burner 150, so as to form a ball. When the soot is continuously deposited so that the ball has a desired size, the core 122a and the inner clad 124a are simultaneously formed on the ball by using the first and second burners 140 and 150. In the case where the first soot preform 120a is directly grown on the end portion of the starting member 110 without the creation of the ball, the weight of the first soot preform 120a may cause the first soot preform 120a to separate from the starting member 110, or to crack. During the soot deposition, the starting member 110 rotates and moves upward. The starting member 110 is rotated around the central axis 112 thereof, so as to allow the first soot preform 120a to have a rotation symmetry. Further, the starting member 110 is moved upward along the central axis 112 thereof, thereby making the first soot preform 120a continuously grow downward. The growth direction of the first soot preform 120a on the central axis 112 of the starting member 110 is referred to as “downward”, while a reverse direction is called “upward”. In a preferred embodiment, the upward movement of the starting member 110 is servo-controlled by using a sensor. Specifically, the sensor measures the growth of the first soot preform 120a, i.e. diameter or length, and enables the starting member 110 to move upward when the growth of the first soot preform 120a reaches a preset value. Thus, the starting member 110 automatically moves upward according to the growth of the first soot preform 120a.

The first burner 140 has a central axis inclined at an acute angle with respect to the central axis 112 of the starting member 110, and sprays flame toward the end portion of the first soot preform 120a so as to grow the core 122a downward from an end portion of the first soot perform 120a. The first burner 140 is provided with source materials S including SiCl₄, which is a material to form glass, and a refractive index control material such as GeCl₄, POCl₃, or BCl₃, fuel gas G_{F} including hydrogen, and oxide gas G_{O} including oxygen. The source materials are dissolved by hydrolysis in the flame sprayed from the first burner 140 so as to generate a soot. Then, the generated soot is deposited on the first soot preform 120a.

The hydrolysis relating to SiO₂ and GeO₂ which are main oxides constructing the soot is expressed by following chemical formulas (1) and (2). At this time, the reaction temperature is within a range of 700˜800° C.

SiCl₄+2H₂+O₂→SiO₂+4HCl (1)

GeCl₄+2H₂→GeO₂+4HCl (2)

The second burner 150 is disposed over the first burner 140 and spaced apart from the first burner 140, and has a central axis inclined at an acute angle with respect to the central axis 112 of the starting member 110. The second burner 150 sprays flame toward an outer peripheral surface of the core 122a, so as to grow an inner clad 124a on the outer peripheral surface of the core 122a. The second burner 150 is provided with a source material S including SiCl₄ which is a material to form glass, fuel gas G_{F} including hydrogen and oxide gas G_{O} including oxygen. The source material is dissolved by hydrolysis in the flame sprayed from the second burner 150 so as to generate a soot. The generated soot is deposited on the first soot preform 120a.

The quantity and the kinds of the source material S supplied to the first and second burners 140 and 150 are differently controlled, so that the core 122a has a higher refractive index than that of the inner clad 124a. For example, germanium and phosphorus increase the refractive index, while boron decreases the refractive index. Among the soot generated by the first and second burners 140 and 150, a residual soot which is not deposited on the first soot preform 120a is discharged outside through the exhaust port 135 of the deposition chamber 130.

The step (b) S22 is a process for dehydrating the first soot preform 120a. Specifically, the first soot preform 120a is heated in an atmosphere of chlorine gas (Cl₂), so that OH radicals and impurities existing in the first soot preform 120a are removed.

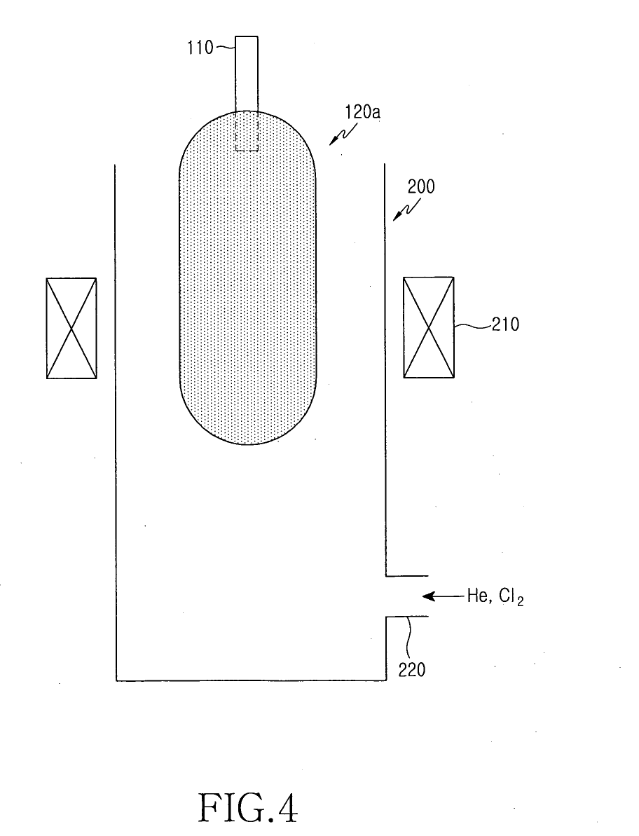

FIG. 4 is a view illustrating a step for dehydrating the first soot preform 120a. A furnace 200 shown in FIG. 4 includes a heater 210, and an inlet 220 provided to a lower portion of the furnace 200

In a step of preparing the first soot preform 120a before the step (b) S22, the first soot preform 120a is disposed in the furnace 200. The chlorine gas and helium gas are supplied through the inlet 220 to the inside of the furnace 200, and then the first soot preform 120a is heated by means of the heater 210. It is preferred that the quantity of the helium gas is set to 20˜50 slpm and the quantity of the chlorine gas is set to 2˜5 vol % of the quantity of the helium gas. For example, the first soot preform 120a may be heated to 1130° C. for one hundred twenty minutes in the atmosphere of the chlorine gas of 1.0 splm and the helium gas of 25 splm.

The step (c) S23 is a process for sintering the first dehydrated soot preform 120a so as to obtain a first optical fiber preform which is glassed.

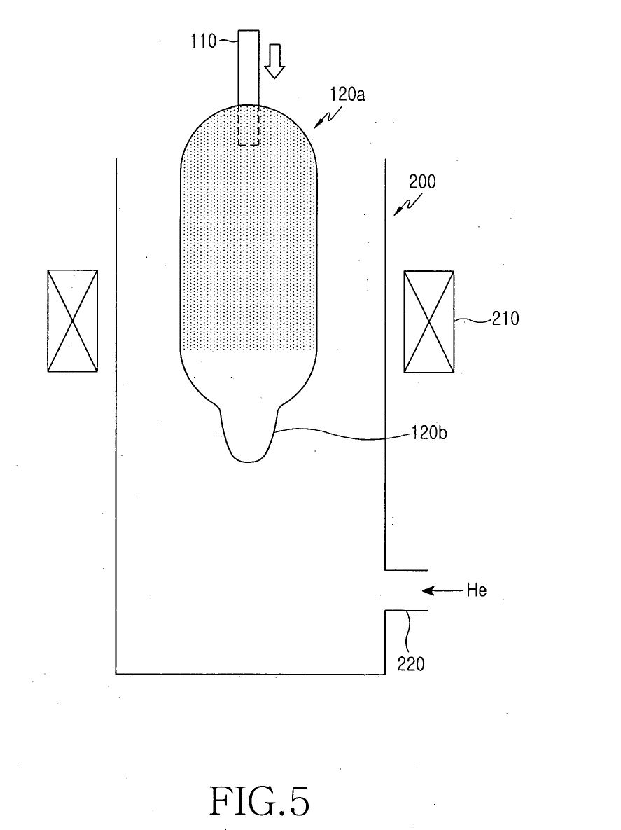

FIG. 5 is a view illustrating a step for sintering the first dehydrated soot preform 120a using the furnace (200) shown in FIG. 4. In the state that the first dehydrated soot preform 120a is disposed in the furnace 200, the helium gas is supplied through the inlet 220 to the inside of the furnace 200, and then the first dehydrated soot preform 120a is heated by means of the heater 210. The first dehydrated soot preform 120a is moved downward so that the first dehydrated soot preform 120a passes through a high temperature region formed by the heater 210 in the furnace 200, from a lower end portion to an upper end portion thereof. As a result of performing the sintering step, a first glassed optical fiber preform 120a is obtained. Specifically, the first soot preform 120a which is opaque is changed into a first transparent optical fiber preform 120b by the sintering process. Since the helium gas has a high thermal conductivity, it is possible to uniformly transfer heat to an interior of the first soot preform 120a. The quantity of the helium gas preferably is between 20˜50 slpm. For example, the first soot preform 120a may be heated to a temperature of 1500° C. in an atmosphere of the helium gas of 25.0 splm for a length of time equal to two hundred minutes.

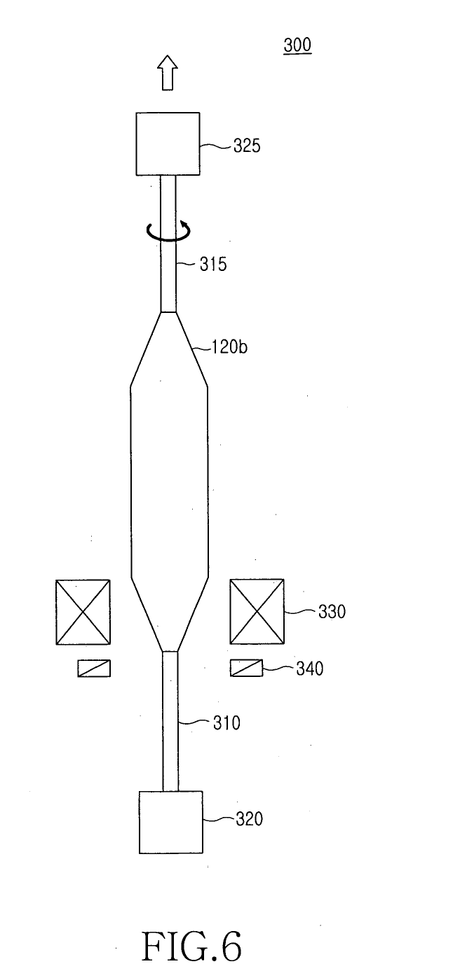

As illustrated in FIG. 6, the step (d) S24 is a process for elongating the first glassed optical fiber preform 120b by heating the first glassed optical fiber preform 120b using a heat source that excludes hydrogen. Specifically, in order to reduce the diameter of the first glassed optical fiber preform 120b and to elongate the length of the first glassed optical fiber prefrom 120b, an end portion of the first optical fiber preform 120b is drawn downward after the first glassed optical fiber preform 120b is softened by heating. In consideration of a ratio of the diameter of the core to that of the clad of the resulting optical fiber, the first glassed optical fiber preform 120b is elongated to have a desired diameter. The heat source that excludes hydrogen includes an electric furnace and a plasma heater, etc.

FIGS. 6 to 8 are views illustrating the steps for heating and elongating the first glassed optical fiber preform 120b. FIGS. 6 to 8 are views respectively and sequentially illustrate an early stage, an intermediate stage, and a final stage of the step (d) S24. An elongation apparatus 300, illustrated in FIGS. 6 to 8, includes first and second chucks 320 and 325, a heater 330, and a device for measuring an outer diameter of the first glassed optical fiber preform 120b.

Referring to FIG. 6, at a preparation step before the step (d) S24, a first dummy rod 310 is attached to a first end of the first glassed optical fiber preform 120b, while a second dummy rod 315 is attached to a second end opposite to the first end of the first glassed optical fiber preform 120b. The first and second dummy rods 310 and 315 extend along the central axis (or a longitudinal direction) of the first glassed optical preform 120b. The first dummy rod 310 is fixed by the first chuck 320, while the second dummy rod 315 is clamped by the second chuck 325. At this time, in order to prevent the first glassed optical fiber preform 120b from being bent during the elongation step, the first optical preform 120b has the first end located at a low portion of the elongation apparatus and the second end at the upper portion of the elongation apparatus, both of which are aligned perpendicular to the ground. Thus, the first chuck 320 is disposed at the low portion of the elongation apparatus, while the second end 325 is disposed at the upper portion of the elongation apparatus. The heater 330 and an outer diameter measurement device 340 are disposed around the first glassed optical fiber preform 120b. In order to measure the diameter of the first elongated glassed optical fiber preform. 120b, the outer diameter measurement device 340 is disposed below the heater 330.

Further, in a preparation step before the step (d) S24, the diameter of the first glassed optical fiber preform 120b is measured along an entire length of the first glassed optical fiber preform 120b by using the outer diameter device 340. As a result of the measurement, an upward movement velocity of the second chuck 325 and a heating temperature of the heater 330 can be calculated.

Referring to FIGS. 6 to 8, when the heating temperature of the heater 330 is increasing and the first glassed optical fiber preform 120b is rotated around its central axis at a constant velocity, the heater 330 and the outer diameter measurement device 340 are caused to move upward while a distance between the heater 330 and the outer diameter measurement device 340 is constantly maintained. The heater 330 moves in a region between the first and second ends of the first glassed optical fiber preform 120b. At this time, the heater 330 has a movement velocity faster than that of the second chuck 325. Further, the outer diameter measurement device 340 monitors the diameter of the first glassed optical fiber preform 120b. The rotation of the first glassed optical fiber preform 120b is to prevent the first glassed optical fiber preform 120b from becoming ovoid in a cross-section thereof, which rotation alternatively may be omitted during the step (d). The heater 330 is preferably heated in a range of the temperature of 1800˜2100° C. Further, an electric resistance furnace or an electric induction furnace is prefereably used as the heater 330. For example, the heating temperature of the furnace is maintained at 2,000° C., while the movement velocity of the second chuck 325 is at 45˜50 mm/min. Furthermore, a feed velocity, which is a difference of the movement velocity between the second chuck 325 and the furnace 330, is 7.5 mm/min, while a rotation velocity of the first glassed optical fiber preform 120b is set to 1 rpm. Meanwhile, a tensile strength applied to the second chuck 325 is preferably maintained at 100˜200N.

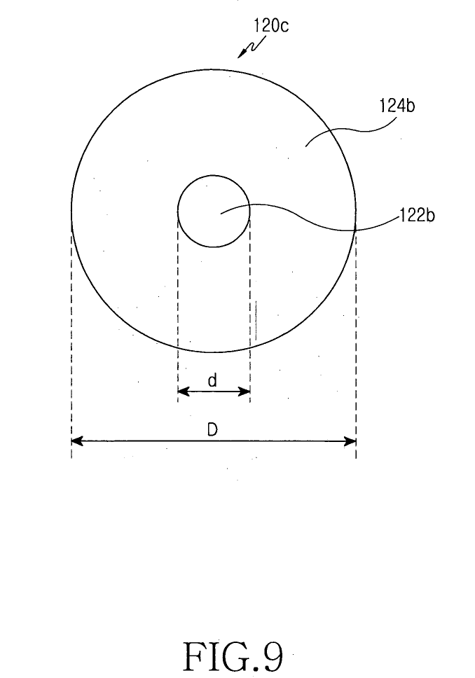

FIG. 9 is a cross-section view showing the first glassed optical fiber preform 120c which is elongated. The first elongated glassed optical fiber preform 120c includes a core 122b having a diameter d, and an inner clad 124b having a diameter D. As the step (d) S24 is carried out by a heat source that excludes hydrogen, it is possible to minimize the permeation of hydrogen into the core 122b of the first elongated glassed optical fiber preform 120c. Thus, a ratio D/d of the diameter D of the inner clad 124b to the diameter d of the core 122b is set below 5.0, preferably in a range of 4.1 to 4.5.

Then, the first elongated glassed optical fiber preform 120c is cut and divided into a first cut and a second cut such that the first dummy rod 310 is attached to the first cut and the second dummy rod 315 is attached to the second cut. The first cut elongated glassed optical fiber preform 120c, to which the first dummy rod 310 is attached, is used in the following steps.

The step (e) S25 is a process for growing an outer clad on the first cut elongated glassed optical fiber preform 120c in a radial direction of the first cut elongated glassed optical fiber preform 120c, so as to obtain the second soot preform. The outer clad preferably has the same composition and refractive index as those of the inner clad of the first cut elongated glassed optical fiber preform 120c. The outer clad is directly formed on an outer periphery of the inner clad of the first cut elongated glassed optical fiber preform 120c.

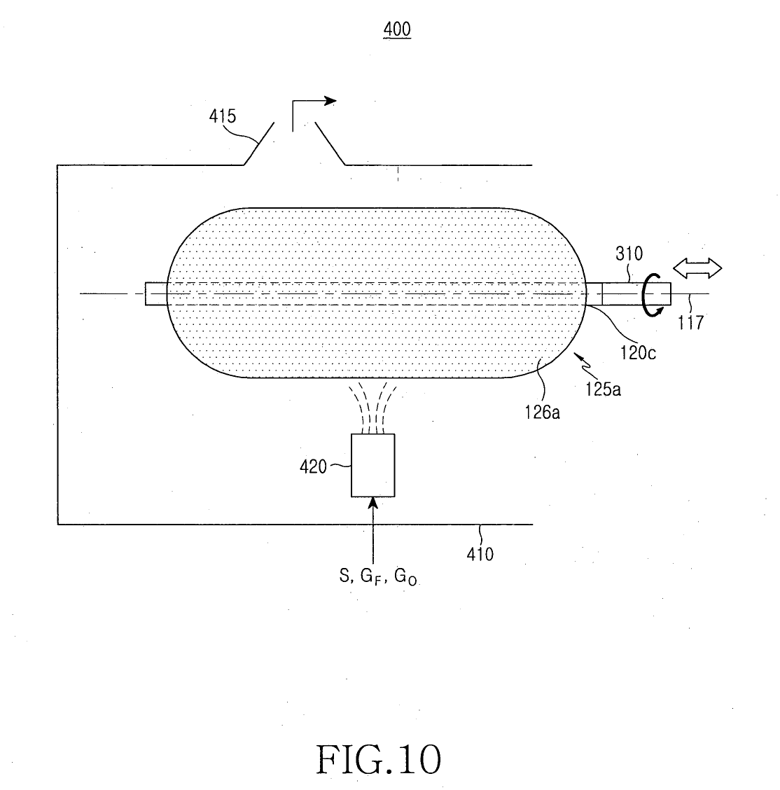

FIG. 10 is a view illustrating the step of growing the outer clad. An apparatus 400 for fabricating an optical fiber preform, shown in FIG. 10, includes a deposition chamber 410 and a burner 420. In a preparation step before the step (e) S25, the first cut elongated glassed optical fiber preform 120c is disposed in the deposition chamber 410.

The deposition chamber 410 has a cylindrical shape comprising an inner space, and is provided with an exhaust port 415. The burner 420 is disposed opposite to the exhaust port 415 so as to have the first cut elongated glassed optical fiber preform 120c between the burner 420 and the exhaust port 415. The outer clad 126a is grown by a soot deposition using the burner 420 on an outer periphery of the first cut elongated glassed optical fiber preform 120c in a radial direction. During the soot deposition, the first cut elongated glassed optical fiber preform 120c is rotated and simultaneously moved along a central axis 117 thereof. As the first cut elongated glassed optical fiber preform 120c rotates about the central axis 117, the second soot preform 125a has rotation symmetry. Further, the first cut elongated glassed optical fiber preform 120c is caused to repeatedly move along the central axis 117, so as to obtain the second soot preform 125a. At this time, the burner 420 is fixed to the deposition chamber 410.

The burner 420 is supplied with a source material S including SiCl₄ which is a material to form glass, fuel gas G_{F} including hydrogen, oxide gas G_{O} including oxygen, etc. As the source material S is dissolved by hydrolysis in flame sprayed from the burner 420, soot is generated. The generated soot is deposited on an outer peripheral surface of the first cut elongated glassed optical fiber preform 120c to produce a second soot perform which is opaque 125a. The residual soot, which is not deposited on the outer peripheral surface of the first cut elongated glassed optical fiber preform 120c, among the soot generated by the burner 420 is discharged outside through the exhaust port 415 of the deposition chamber 410.

Alternatively, the burner 410 may be repeatedly moved parallel to the central axis 117 of the first cut optical fiber preform 120c instead of moving the first cut elongated glassed optical fiber preform 120c.

The step (f) S26 is a process of dehydrating and sintering the second soot prefrom 125a, so as to obtain a second glassed optical fiber preform. Specifically, the dehydration step is carried out by heating the second soot preform 125a in an atmosphere of chlorine gas, in order to remove OH radicals and impurities which are present in the second soot preform 125a. At the same time, the second soot preform 125a is sintered in an atmosphere of helium gas, so as to cause the second soot perform 125a to be glassed.

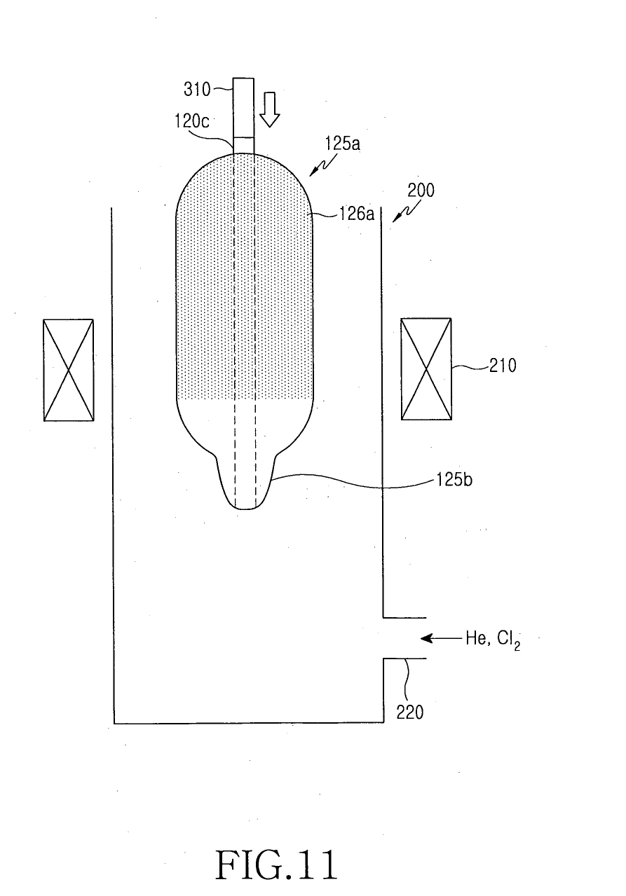

FIG. 11 is a view illustrating steps of dehydrating and sintering the second soot preform 125a using the furnace 200 shown in FIG. 4. When the second soot preform 125a is disposed in the furnace 200, the helium gas and the chlorine gas are supplied to the inside of the furnace 200 and the second soot preform is heated by using the heater 210. The second soot preform 125a is then moved downward at a preset velocity so that a lower end and an upper end of the second soot preform 125a pass through a high temperature region formed in the furnace 200. By performing the dehydrating and sintering processes, it is possible to remove the OH radicals and the impurities which are present in the second soot preform 125a and simultaneously to obtain the second glassed optical fiber preform 125b. Specifically, the second soot preform 125a which is opaque is changed into a second transparent optical fiber preform 125b through the dehydration and sintering processes.

Preferably, a quantity of the helium gas, which is supplied to the furnace, is in the 10 to 20 slpm, and a quantity of the chlorine gas, which is supplied to the furnace, is in the range 1 to 4 vol % with relation to the quantity of the helium gas. For example, the second soot preform is heated to a temperature of 1500° C. in an atmosphere of the chlorine gas of 0.375 splm and the helium gas of 15.0 splm for a length of time equal to three hundred minutes.

The conventional art does not dehydrate but only sinters the second soot preform. However, the present invention dehydrates and sinters the second soot preform 125a, so as to reduce a loss of a low water peak optical fiber due to the OH radicals.

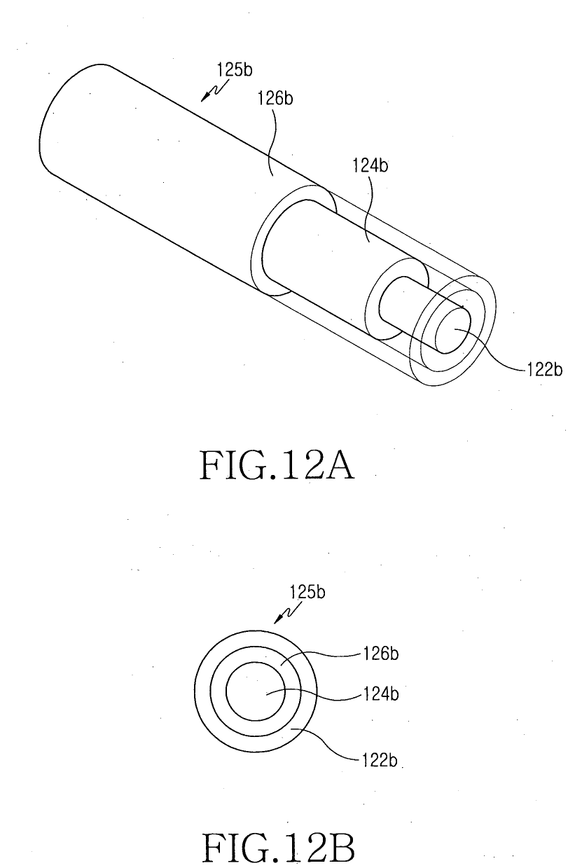

FIG. 12 is a view showing the second optical fiber preform 125b. FIG. 12A is a perspective view of the second optical fiber preform 125b, and FIG. 12b is a cross-section view of the second optical fiber prefrom 125b. As shown in FIG. 12, the second optical fiber preform 125b includes a core 122b located at its center portion, an inner clad 124b surrounding the core 122b, and an outer clad 126b surrounding the inner clad 124b.

Then, a low water peak optical fiber is drawn from the second optical fiber preform 125b which is fabricated by the above-mentioned method. The low water peak optical fiber has the same structure and diameter ratio as those of the second optical fiber preform 125b. The core of the low water peak optical fiber becomes a medium for carrying optical signals, and the inner clad functions to confine the optical signals within the core. Also, the outer clad increases the diameter of the low water peak optical fiber. Further, the diameter ratios among the core, the inner clad, and the outer clad of the low water peak optical fiber are identical to the diameter ratios among the core 122b, the inner clad 124b, and the outer clad 126b of the second optical fiber preform 125b.

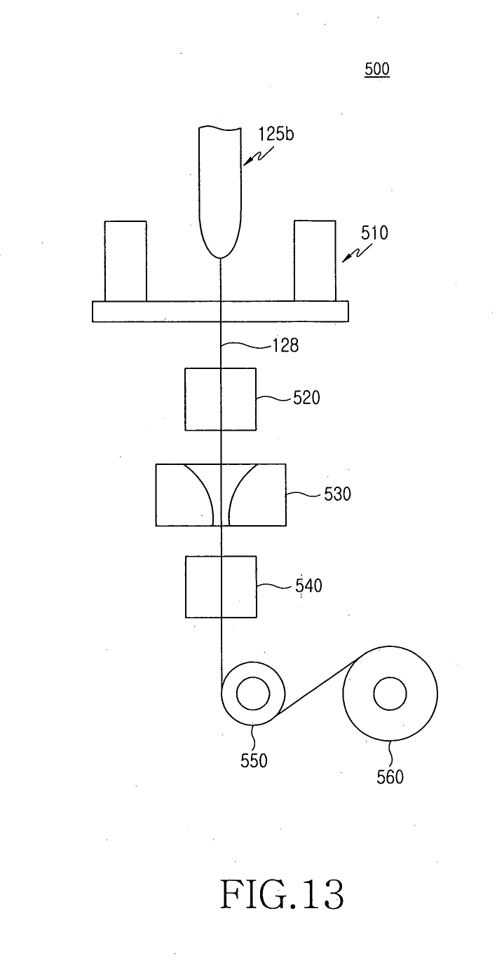

FIG. 13 is a view illustrating a step of drawing the low water peak optical fiber. A drawing apparatus 500 illustrated in FIG. 13 includes a furnace 510, a cooler 520, a coater 530, an ultraviolet hardener 540, a capstan 550, and a spool 560.

The furnace 510 heats an end portion of the second optical fiber preform 125b, which is disposed therein, to a temperature in the range of 2600 to 2700° C., inclusive, and softens it. The low water peak optical fiber 128, which is drawn from the second optical fiber preform 125b, has an identical structure to the second optical fiber preform 125b, but has a much smaller diameter than that of the second optical fiber preform 125b. Meanwhile, in order to prevent the inside of the furnace 510 from being burned due to heat, inert gas is made to flow within the furnace 510.

The cooler 520 cools the heated and softened low water peak optical fiber 128 which is drawn from the furnace 510.

The coater 530 coats a resin onto the heated and softened low water peak optical fiber 128 which passes through the cooler 520, and the ultraviolet hardener 540 emits ultraviolet rays to the resin so as to harden the resin.

The capstan 550 pulls the low water peak optical fiber 128 with predetermined force, and continuously draws the low water peak optical fiber 128, which has a constant diameter, from the second optical fiber preform 125b.

After passing through the capstan 550, the low water peak optical fiber 128 is wound on the spool 560.

The low water peak optical fiber 128 satisfies the standards of ITU-T G652C or G652D, and has the maximum peak value below 0.4 dB/km at a wavelength of 1310˜1625 nm. After being subjected to hydrogen aging, the low water peak optical fiber 128 has a peak value at a wavelength of 1383 nm less than that at the wavelength of 1310 nm.

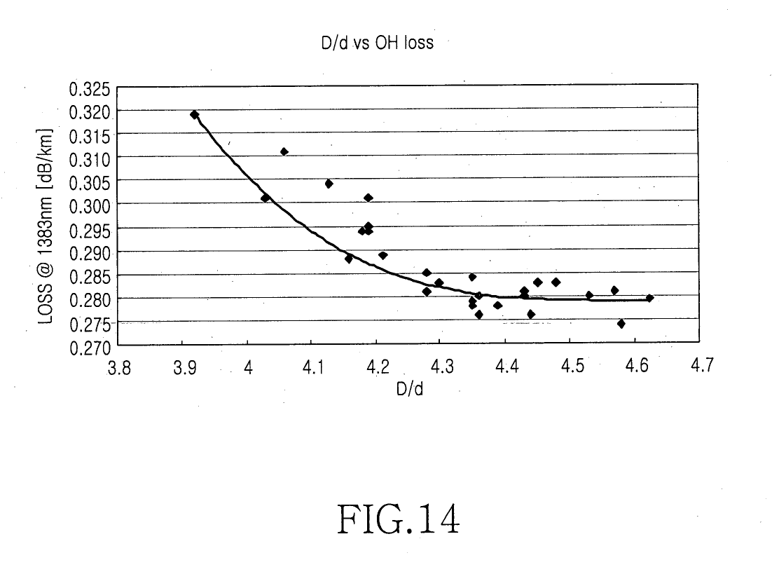

FIG. 14 is illustrates a loss characteristic of the low water peak optical fiber 128. In FIG. 14, a horizontal axis shows a diameter ratio D/d of the diameter of the inner clad to the diameter of the core d of the low water peak optical fiber 128, and a vertical axis shows the loss value of the low water peak optical fiber caused by the OH radical at a wavelength of 1383 nm. As illustrated in FIG. 14, even in the case where the ratio D/d is below 5.0, the loss value is remarkably low. When the ratio D/d is within a range of 4.1˜4.5, the diameter ratio and the loss value are simultaneously lowered.

As described, in the method for fabricating the optical fiber preform and the method for fabricating the low water peak optical fiber using the optical fiber preform, according to the present invention, the first optical fiber preform is elongated by a heat source that excludes hydrogen, thereby minimizing the permeation of hydrogen into the core. Thus, it is possible to reduce the diameter ratio of the core and the inner clad of the first optical fiber perform, thereby reducing the manufacturing cost and time of the optical fiber preform and facilitating fabrication of the low water peak optical fiber.

Further, in the method for fabricating the optical fiber and the method for fabricating the low water peak optical fiber using the optical fiber preform, according to the present invention, it is possible to dehydrate and sinter the second soot perform, thereby reducing the loss of the low water peak optical fiber caused by the OH radical.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for fabricating an optical fiber preform, comprising the steps of:
(a) growing a first soot preform on a starting member along a lengthwise direction of the starting member by a soot deposition;
(b) dehydrating the first soot preform;
(c) sintering the dehydrated first soot preform, to obtain a first glassed optical preform; and
(d) elongating the first glassed optical fiber preform by heating the first glassed optical fiber perform with a heat source that excludes hydrogen to obtain a first elongated glassed optical fiber preform.

2. The method of claim 1, further comprising the steps of:
(e) growing an external clad on the first elongated glassed optical fiber preform by the soot deposition to obtain a second soot preform; and
(f) dehydrating and sintering the second soot preform to obtain a second glassed optical fiber preform.

3. The method of claim 2, wherein step (f) is carried out in an atmosphere of a combination of chlorine gas and helium gas.

4. The method of claim 1, wherein the first elongated glassed optical fiber preform includes a core located at a center portion thereof, and an inner clad formed on an outer periphery of the core and having a low refractive index.

5. The method of claim 4, wherein a ratio D/d of a diameter D of the inner clad to a diameter d of the core with respect to the first elongated glassed optical fiber preform is less than 5.0.

6. The method of claim 4, wherein a ratio D/d of a diameter D of the inner clad to a diameter d of the core with respect to the first elongated glassed optical fiber preform is within a range of 4.1 to 4.5, inclusive.

7. A method for fabricating a low water peak optical fiber, comprising the steps of:
(a) growing a first soot preform on a starting member along a lengthwise direction of the starting member by a soot deposition;
(b) dehydrating the first soot preform;
(c) sintering the dehydrated first soot preform, to obtain a first glassed optical preform;
(d) elongating the first glassed optical fiber preform by heating the first glassed optical fiber with a heat source that excludes hydrogen;
(e) growing an outer clad on the first elongated glassed optical fiber preform by the soot deposition, to obtain a second soot preform;
(f) dehydrating and sintering the second soot preform to obtain a second glassed optical fiber preform; and
(g) drawing a low water peak optical fiber by heating and softening an end portion of the second glassed optical fiber preform.

8. The method of claim 7, wherein step (f) is carried out in an atmosphere of a combination of chlorine gas and helium gas.

9. The method of claim 7, wherein the drawn low water peak optical fiber includes a core located at a center portion of the drawn low water peak optical fiber, an inner clad formed on an outer periphery of the core and having a refractive index less than that of the core, and an outer clad directly formed on a periphery of the inner clad.

10. The method as claimed in claim 9, wherein a ratio D/d of a diameter D of the inner clad to a diameter d of the core with respect to the drawn low water peak optical fiber is less than 5.0.

11. The method of claim 9, wherein a ratio D/d of a diameter D of the inner clad to a diameter d of the core with respect to the drawn low water peak optical fiber is within a range of 4.1 to 4.5, inclusive.
